(19) United States
(12) Patent Application Publication
(10) Pub. No.: US 2013/0086395 A1
(43) Pub. Date: Apr. 4, 2013

(54) Multi-Core Microprocessor Reliability Optimization

(71) Applicant: Jonathan H. Liu, San Diego, CA (US)

(72) Inventor: Jonathan H. Liu, San Diego, CA (US)

(73) Assignee: QUALCOMM INCORPORATED, San Diego, CA (US)

(21) Appl. No.: 13/249,600

(22) Filed: Sep. 30, 2011

(51) Int. Cl. G06F 1/26

(52) U.S. Cl. 713/300

(57) ABSTRACT

Systems and methods for improving effective aging of a multi-core processor. Aging characteristics of the two or more cores of the multi-core processor are determined. Priority determination logic is configured to assign priorities for powering on the cores based on the aging characteristics. Optionally, an operating environment is detected and assigning priorities to the cores is based on a relative power consumption of each of the cores and the operating environment, in order to improve battery life.

### FIELD OF DISCLOSURE

Disclosed embodiments are directed to multi-core processing systems. More particularly, exemplary embodiments are directed to power-on/power-off schemes for efficient management of multiple cores in multi-core microprocessors.

### BACKGROUND

Multi-core computer processing systems are becoming increasingly common. Two or more processing cores/processors are integrated into the same system, and may be disposed in the same integrated circuit die or physical package. The multiple cores facilitate simultaneous processing of several instruction streams.

With reference to FIG. 1, a schematic illustration of conventional multi-core processor 100, with four cores, is provided. Each of cores 101-104 is shown to comprise a CPU and an associated local cache. However, individual cores may alternatively have no local cache, or may comprise several levels of cache structures. Cores 101-104 may also be coupled to a main memory 105 as illustrated.

However, multi-core processor 100 may not require engagement of all four of cores 101-104 at all times. Depending on the application that is being executed, there may be instances wherein processing needs of multi-core processor 100 can be met using only a single core. The architecture of multi-core processor 100 may comprise designation of one of the cores, such as core 101, as a primary core, such that when only one core is active, the primary core (core 101) will always be selected to power up first and remain powered on to handle the processing needs of multi-core processor 100. The remaining cores (cores 102-104), designated as secondary cores, will remain powered off unless system software senses that one or more of these secondary cores need to be powered on in order to handle additional processing needs of the multi-core processor 100. Further, one of the secondary cores 102-104 will be first to be powered off when more than one core ceases to be required, and primary core 101 will be last to be powered off.

As can be seen, architectures such as conventional multi-core processor 100 place an increased and unbalanced stress on primary core 101, as primary core 101 is powered on and utilized much more heavily than any of secondary cores 102-104. This in turn degrades the reliability and lifetime of primary core 101. This may result in degradation of reliability and lifetime of secondary cores 102-104 that is not proportional to that of primary core 101, as they are subjected to less operating stress. Accordingly the reliability, performance, and lifetime of multi-core processor 100 may be limited by the reliability, performance, and lifetime of primary core 101.

There is a corresponding need in the art for multi-core processors that are configured to distribute operating stress in a balanced manner among the two or more cores.

### SUMMARY

Exemplary embodiments of the invention are directed to systems and method for balancing aging effects in a multi-core processor.

For example, an exemplary embodiment is directed to a method for improving effective aging of a multi-core processor comprising: determining aging characteristics of two or more cores of the multi-core processor; and assigning priorities for powering on the cores based on the aging characteristics.

Another exemplary embodiment is directed to a method for improving effective aging of a multi-core processor comprising: randomly selecting a first core to be powered on before powering on the other cores. A random number generator may be configured to randomly select the first core, and powering on the other cores may be based on aging characteristics of the other cores.

Another exemplary embodiment is directed to a method for managing a multi-core processor comprising: detecting an operating environment; and assigning priorities for powering on the two or more cores of the multi-core processor based on a relative power consumption of the cores or the operating environment.

Another exemplary embodiment is directed to a multi-core processor comprising: two or more cores; logic configured to determine aging characteristics of the two or more cores; and priority determination logic configured to assign priorities for powering on the cores based on the aging characteristics.

Another exemplary embodiment is directed to a processing system comprising: two or more cores; means for determining aging characteristics of the two or more cores; and means for assigning priorities for powering on the cores based on the aging characteristics.

Yet another exemplary embodiment is directed to a non-transitory computer-readable storage medium comprising code, which, when executed by a processor, causes the processor to perform operations for improving effective aging of a multi-core processor, the non-transitory computer-readable storage medium comprising code for determining aging characteristics of two or more cores of the multi-core processor; and code for assigning priorities for powering on the cores based on the aging characteristics.

### BRIEF DESCRIPTION OF THE DRAWINGS

The accompanying drawings are presented to aid in the description of embodiments of the invention and are provided solely for illustration of the embodiments and not limitation thereof.

FIG. 1 is a schematic illustration of a conventional multi-core processor with four cores.

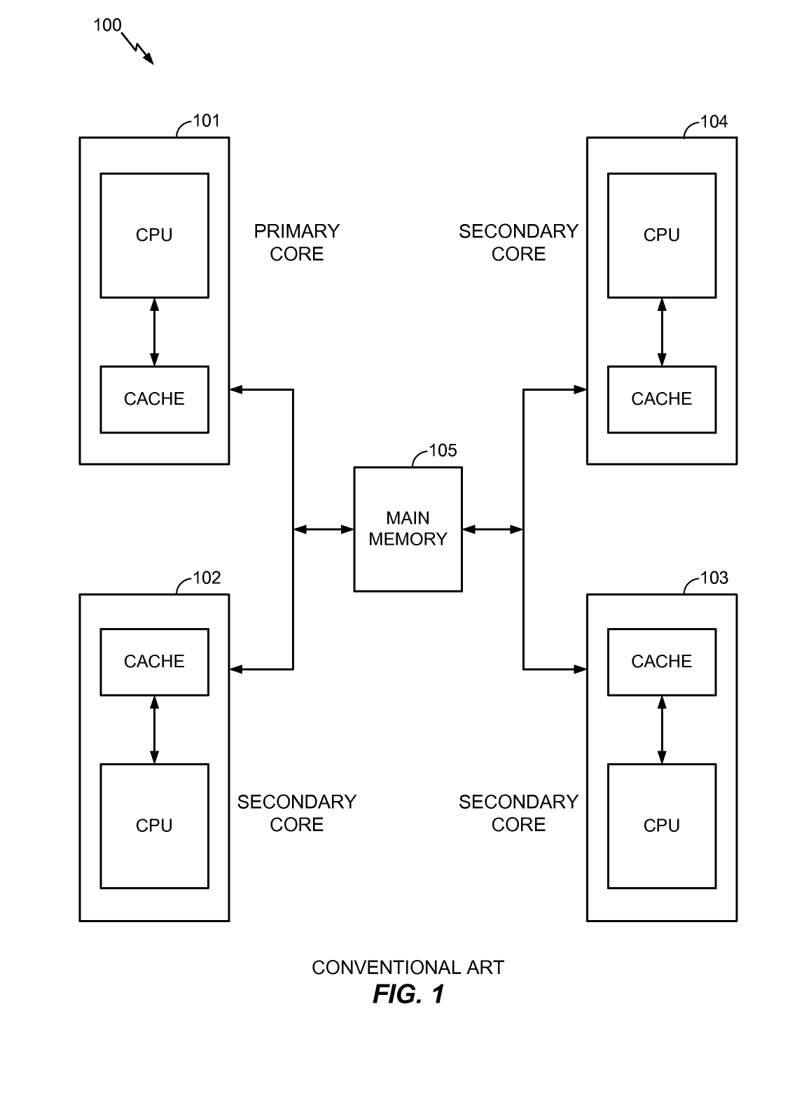

FIG. 2 illustrates a multi-core processor with four cores and priority detection logic according to exemplary embodiments.

FIG. 3 is a flow chart illustrating a method of balancing effective aging in an exemplary multi-core processor.

FIG. 4 illustrates an exemplary wireless communication system 400 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments recognize the undesirable effects on reliability, performance, and lifetime of conventional multi-core processors such as multi-core processor 100, caused by placing increased and unbalanced operating stress on a single core (the primary core). Accordingly, embodiments include usage models for improving reliability, performance, and lifetime of exemplary multi-core processors based on balancing the load and operating stress among the two or more cores. Exemplary embodiments comprise techniques for assigning priorities to the two or more cores for balancing the operating stress and aging characteristics among the two or more cores.

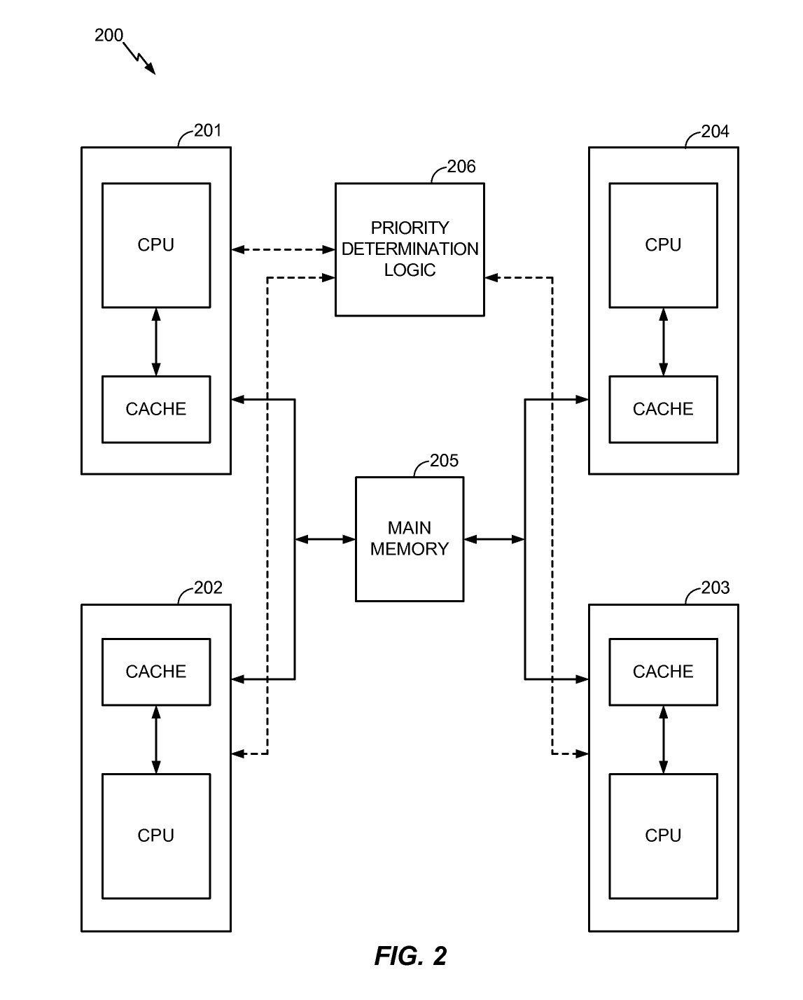

With reference now to FIG. 2, multi-core processor 200, according to exemplary embodiments, is illustrated. Similar to conventional multi-core processor 100, multi-core processor 200 may comprise cores 201-204 (which may include a CPU and a local cache), and wherein cores 201-204 may be operatively coupled to main memory 205. However, unlike conventional multi-core processor 100, multi-core processor 200 may not include predetermined designation of one or more cores as primary cores or one or more cores as secondary cores. Instead, as illustrated, multi-core processor 200 may include priority determination logic 206 which may be configured to assign priorities to cores 201-204. Priority determination logic 206 may assign priorities by alternating selection of one of cores 201-204 as a high priority core, while designating the remaining cores as low priority cores. Priority determination may be based on aging characteristics related to parameters described hereunder.

In an exemplary embodiment, priority determination may be based on a first-in-first-out (FIFO) type protocol. For example, priority determination logic 206 may implement a protocol for assigning priorities to cores which includes assigning a lowest priority for the core which was the first to power on. In other words, a core which is first to power-on may be designated as the core which is first to power-off.

In another exemplary embodiment, priority determination may be based on aging characteristics related to power management. For example, priority determination logic 206 may implement intelligent power management schemes to assign priorities to cores 201-204. For example, power-on/power-off sequences may be implemented in priority determination logic 206, such that balanced “on-time” may be allocated to cores 201-204. As used herein, “on-time” for a particular core refers to the duration of time that the core is powered on. One of ordinary skill will understand that while reference is made herein to power-on and power-off, suitable variations are envisioned as within the scope of the embodiments. For example, priority determination logic 206 may include logic for clock gating, frequency scaling, and/or voltage scaling techniques configured to lower leakage power of cores, instead of completely powering off the core. In exemplary embodiments, priority determination logic 206 may implement fuse registers to indicate leakage and operating power of different cores during product testing, such that the system hardware or software can use the core power ratings recorded in the fuse registers and on-die temperature sensor to optimize product power consumption and temperature. For example, if power consumption values of the corresponding circuitry or cores exceed the thresholds, the corresponding circuitry or cores may be selected to have less “power-on” time to reduce total power consumption or product temperature, particularly when the multi-core processor is already operating at high temperatures. Further, references to “power-off” states as used herein, may encompass standby or idle states in addition to complete power-off or shut-down states.

In another exemplary embodiment, priority determination may be based on aging characteristics related to voltage. For example, priority determination logic 206 may include adaptive voltage scaling mechanisms, such that for cores 201-204 which are at higher operating temperatures, the operating voltage of the cores may be lowered. Thus, the maximum frequency of operation at that voltage (Fmax) may be correspondingly scaled down. As a result, individual cores among cores 201-204 may exhibit different maximum frequencies, such that all four cores 201-204 may operate in safe and reliable temperature and voltage conditions. Thus, a likelihood of frequent thermal throttling may be lowered, such that overall product performance remains relatively constant. The effective reliability stresses of cores 201-204 may be balanced accordingly, thereby prolonging the lifetime of multi-core processor 200.

Similarly, in another exemplary embodiment, priority determination may be based on aging characteristics related to operating temperature of the cores. For example, priority determination logic 206 may implement prioritization protocols based on operating temperatures of cores 201-204. On-die temperature sensors may be used to analyze operating temperatures of cores 201-204. A higher operating temperature may be correlated with a higher operating stress/increased workload. Accordingly, a core with lower operating temperature may be accorded higher priority. Further, when additional cores are needed to be powered-on to share the workload, cores at lower temperatures may be assigned higher priority. In cases where multi-core processor 200 is operated in high temperature environments, priority determination logic 206 may employ prioritization protocols based on operating temperatures of cores in order to prevent multi-core processor 200 from becoming overheated. Thus, operating temperatures in over-heated cores may be lowered by redistributing work load to cores with lower operating temperatures.

In related cases, a determination of whether a core may move to a higher frequency may be based on whether the core has sufficient temperature headroom. If a core does not have sufficient temperature headroom, the move to a higher frequency may result in thermal throttling and lead to lower performance. In cases where multiple cores are powered-on, cores at lower temperatures may be assigned higher priority for moves to higher frequency states. In an illustrative example, all four cores 201-204 may be configured to operate at a frequency of 1 GHz. A “turbo” mode may be defined at a frequency of 1.2 GHz. In this example, if a need for the turbo mode of operation were to arise, the core at the lowest temperature among cores 201-204 may be selected to transition to the turbo mode first.

In yet another exemplary embodiment, priority determination may be based on aging characteristics related to reliability or degradation of cores. For example, priority determination logic 206 may include an on-die reliability/aging monitor or sensor to assess an amount of device degradation in cores 201-204. The aging monitor may be implemented based on transistor or circuit performance degradation. Lookup tables may be included in the aging monitor for correlating operating temperature and leakage power measurements to reliability/aging. High priority may be assigned to cores 201-204 which exhibit low values of device degradation, while lower priority may be assigned to cores 201-204 which exhibit high degradation. In this manner, device degradation may be balanced across cores 201-204 such that variation in frequency degradation of the multi-core processor may be minimized. Further, the prioritization protocols may also balance operating frequency degradation among cores 201-204, such that a frequency guard-band (Fmax GB) of multi-core processor 200 may be reduced. As will be understood by one of ordinary skill in the art, reducing the Fmax GB may improve product performance and yield.

Conservation of power plays a crucial role in multi-core processors, especially as employed in handheld devices and mobile applications. Limiting power consumption may improve battery life, and thereby improve lifetime and product reliability. Accordingly, in exemplary embodiments, priority determination may be based on aging characteristics related to power consumption of individual cores. For example, similar to the employment of on-die temperature and reliability sensors, as described above, priority determination logic 206 may include sensors which may be configured to measure power consumption of cores 201-204. Higher priority may be assigned to cores with lower power consumption.

Moreover, in embodiments related to aging characteristics based on power consumption, priority determination logic 206 may enforce power-on rotation schemes among cores 201-204. In these embodiments the same core may be prevented from being powered on twice in a row, for example, by preventing power-on of the same core without powering on a different core in between. Alternately, each of cores 201-204 may be given equal priority to be powered on first, such that a power-on sequence rotates successive assignment of high and low priorities to each of the cores 201-204. Corresponding power-off sequences in multi-core processor 200 may follow a first-in-first-out (FIFO) protocol, such that a core which was powered on first will also be the core that is powered off first.

Aging of multi-core processor 200 may also be managed by randomly selecting one of cores 201-204 to be a high priority core for the purpose of being powered on first. For example, priority determination logic 206 may include (or be replaced by) a random number generator which may be used for the random selection of the high priority core to be powered on first. The random number generator may be implemented in hardware or software, and may be used to generate random patterns for power-on/power-off sequences. In some embodiments, once the high priority core is randomly selected, the remainder of the power-on/power-off sequence may be determined by hardware or software according to techniques for assigning priorities to cores 201-204 based on aging characteristics described with regard to other exemplary embodiments herein.

In yet other exemplary embodiments, priority determination may be based on aging characteristics related to performance levels of cores 201-204, effective aging and lifetime of multi-core processor 200. For example, priority determination logic 206 may implement several performance modes for cores 201-204, such as “high performance” mode and “low performance” mode, wherein more power is consumed in a high performance mode than a low performance mode. A core which has been configured to operate in a high performance mode may consume more processor resources, operate at a higher clock speed, operate at a high processor voltage, etc. Effective aging of exemplary multi-core processors may be balanced by prioritization protocols for selecting cores to transition to high performance mode. In one instance, a core of cores 201-204 with lower operating voltage may be selected to operate in a high performance mode while transitioning one or more of the remaining cores to a low performance mode. Similarly, cores 201-204 may be assigned to operate in high performance mode based on parameters such as low operating temperature, or low power consumption.

Exemplary embodiments may effectively improve power consumption for handheld devices wherein extended battery life is an important consideration. In exemplary embodiments, priority determination logic 206 may implement logic configured to detect an operating environment for an exemplary multi-core processor. Assignment of priority to cores 201-204 may be based on a relative power consumption of each of the cores in the detected operating environment. The relative power consumption of each of the cores may be determined using parameters such as, operating temperature, operating voltage, or operating frequency of each core. The relative power consumption may also be identified by a fuse bit set during product testing. Priority determination logic 206 may also assign priorities based on the state/charge of the battery in the handheld devices. For example, a core with low power consumption may be assigned high priority when the battery is in a low power condition, or not fully charged. A core with higher power consumption may be assigned high priority when the state of the battery is substantially fully charged, or the device is plugged in, such that the battery is charging and wherein the operating temperature of the core is lower than the operating temperature of the other cores.

In the above-described embodiments, priority determination logic 206 may be implemented in software, hardware, or suitable combinations thereof. It will also be understood that while description is provided with respect to four cores 201-204 in exemplary multi-core processor 200, the described systems and methods can be easily extended to any number of processor cores or configurations.

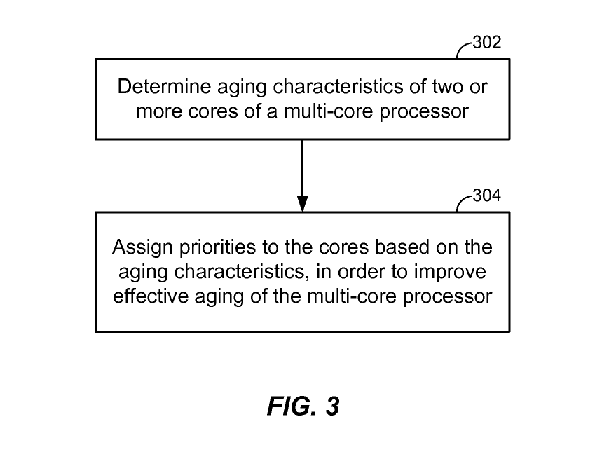

It will be appreciated that exemplary embodiments include various methods for performing the processes, functions and/or algorithms disclosed herein. For example, as illustrated in FIG. 3, an embodiment can include a method for improving effective aging of a multi-core processor (e.g. multi-core processor 200) comprising: determining aging characteristics of two or more cores (e.g. cores 201-204) of the multi-core processor—Block 302; and assigning priorities to the cores based on the aging characteristics (e.g. aging characteristics related to voltage, temperature, power consumption, etc as in above-described embodiments)—Block 304.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

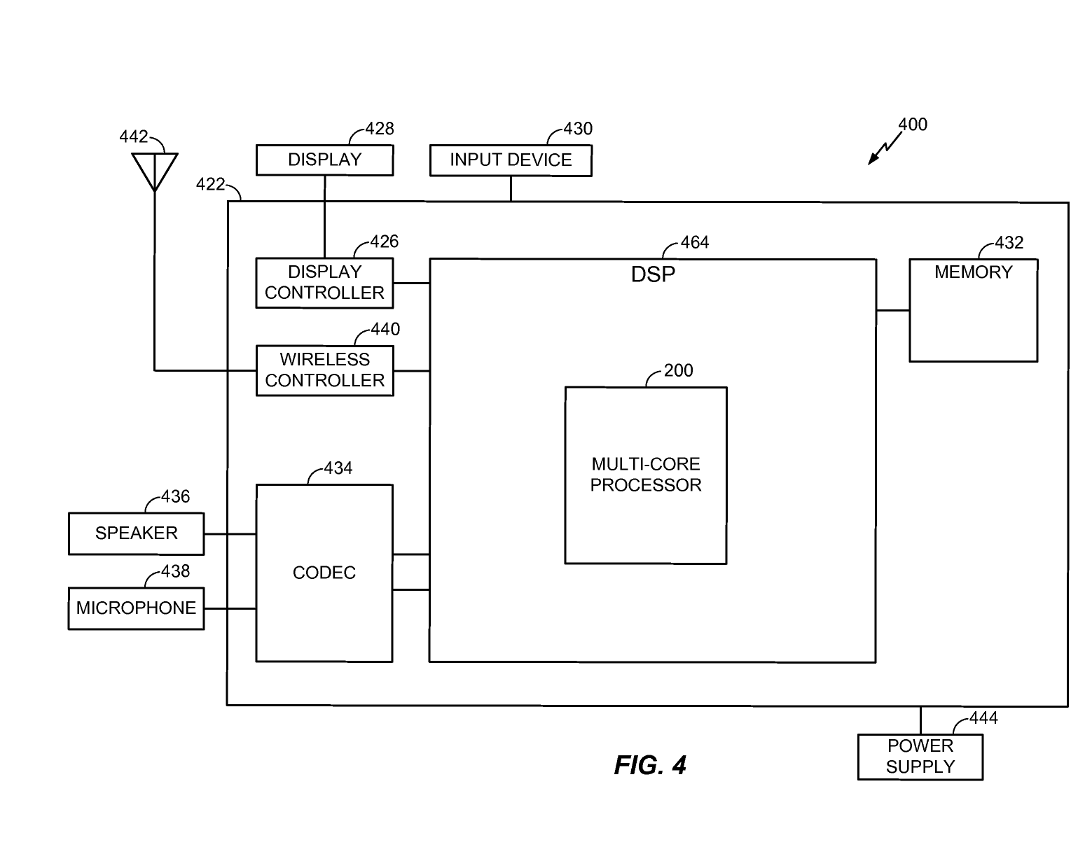

Referring to FIG. 4, a block diagram of a particular illustrative embodiment of a wireless device that includes a multi-core processor configured according to exemplary embodiments is depicted and generally designated 400. The device 400 includes a processor such as digital signal processor (DSP) 464, which may include multi-core processor 200 of FIG. 2. FIG. 4 also shows display controller 426 that is coupled to DSP 464 and to display 428. Coder/decoder (CODEC) 434 (e.g., an audio and/or voice CODEC) can be coupled to DSP 464. Other components, such as display controller 426 (which may include a video CODEC and/or an image processor) and wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., the DSP 464 or a multi-core processor including cores 201-204 of FIG. 2) may also be integrated into such a device.

The foregoing disclosed devices and methods are typically designed and are configured into GDSII and GERBER computer files, stored on a computer readable media. These files are in turn provided to fabrication handlers who fabricate devices based on these files. The resulting products are semiconductor wafers that are then cut into semiconductor die and packaged into a semiconductor chip. The chips are then employed in devices described above.

Accordingly, an embodiment of the invention can include a computer readable media embodying a method for managing effective aging in a multi-core processor. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for improving effective aging of a multi-core processor comprising:
determining aging characteristics of two or more cores of the multi-core processor; and
assigning priorities for powering on the cores based on the aging characteristics.

2. The method of claim 1, wherein determining the aging characteristics comprises determining the core which was first powered on among the two or more cores; and designating the core to be first powered off.

3. The method of claim 1, wherein determining the aging characteristics comprises: detecting an operating voltage level for each core; and wherein assigning priorities comprises assigning high priority to a core with a lower operating voltage level.

4. The method of claim 3, wherein determining the aging characteristics comprises determining a performance mode and operating voltage level associated with the cores, and the method further comprising: transitioning a core with the lower operating voltage level to a high performance mode before another core with a higher operating voltage level.

5. The method of claim 3, further comprising:
powering off a core with a higher operating voltage level before a core with the lower operating voltage level.

6. The method of claim 1, wherein determining the aging characteristic comprises detecting operating temperatures for the cores; and assigning priorities comprises allocating high priority to a core with a lower operating temperature.

7. The method of claim 6, further comprising:
transitioning the core with the lower operating temperature to a high performance mode before another core with a higher operating temperature.

8. The method of claim 6, further comprising:
powering off a core with a higher operating temperature before a core with the lower operating temperature.

9. The method of claim 1, wherein determining the aging characteristic is based on determining power consumption of the cores.

10. The method of claim 9, further comprising, designating a predetermined core for low power consumption by setting a fuse bit.

11. The method of claim 1, wherein determining the aging characteristic comprises detecting a degradation of each core.

12. The method of claim 1, wherein determining the aging characteristic comprises tracking operating parameters for the cores.

13. A method for improving effective aging of a multi-core processor comprising:
randomly selecting a first core to be powered on before powering on the other cores.

14. The method of claim 13, wherein a random number generator is configured to randomly select the first core.

15. The method of claim 13 further comprising powering on the other cores based on aging characteristics of the other cores.

16. A method for managing a multi-core processor comprising:
detecting an operating environment; and
assigning priorities for powering on the two or more cores of the multi-core processor based on a relative power consumption of the cores or the operating environment.

17. The method of claim 16, wherein the operating environment comprises operating temperature of the multi-core processor.

18. The method of claim 16, wherein the operating environment comprises a power state of a battery supplying the multi-core processor.

19. The method of claim 18, further comprising:
assigning high priority to a core with low power consumption when the power state of the battery is low.

20. The method of claim 16, further comprising:
assigning high priority to a core with relatively high power consumption where the power state of the battery is substantially fully charged or charging, and the operating temperature of the core is relatively lower in comparison to the operating temperature of the other cores.

21. The method of claim 16, wherein the relative power consumption of each of the cores is predetermined.

22. The method of claim 21, wherein the relative power consumption of at least one of the cores is identified by a fuse bit set during product testing.

23. The method of claim 16, wherein the relative power consumption of each of the cores is determined using at least one of an operating temperature, voltage, or frequency of each core.

24. A multi-core processor comprising:
two or more cores;
logic configured to determine aging characteristics of the two or more cores; and
priority determination logic configured to assign priorities for powering on the cores based on the aging characteristics.

25. The multi-core processor of claim 24, comprising logic for determining the core which was first powered on among the two or more cores as the core to be first powered off.

26. The multi-core processor of claim 24, comprising logic for detecting an operating voltage level for each core, and logic for assigning high priority to a core with a lower operating voltage level.

27. The multi-core processor of claim 26, comprising logic for determining a performance mode and operating voltage level associated with the cores, and logic for transitioning a core with the lower operating voltage level to a high performance mode before another core with a higher operating voltage level.

28. The multi-core processor of claim 26, further comprising: logic for powering off a core with a higher operating voltage level before a core with the lower operating voltage level.

29. The multi-core processor of claim 24, comprising logic for detecting operating temperatures for the cores and logic for assigning high priority to a core with a lower operating temperature.

30. The multi-core processor of claim 29, further comprising: logic for transitioning the core with the lower operating temperature to a high performance mode before another core with a higher operating temperature.

31. The multi-core processor of claim 29, further comprising: logic for powering off a core with a higher operating temperature before a core with the lower operating temperature.

32. The multi-core processor of claim 24, comprising logic for determining power consumption of the cores.

33. The multi-core processor of claim 32, further comprising a fuse bit for designating a predetermined core for low power consumption.

34. The multi-core processor of claim 24, comprising logic for detecting a degradation of each core.

35. The multi-core processor of claim 24, comprising logic for tracking operating parameters for the cores.

36. The multi-core processor of claim 24, integrated in at least one semiconductor die.

37. The multi-core processor of claim 24, integrated into a device, selected from the group consisting of a set top box, music player, video player, entertainment unit, navigation device, communications device, personal digital assistant (PDA), fixed location data unit, and a computer.

38. A processing system comprising:
two or more cores;
means for determining aging characteristics of the two or more cores; and
means for assigning priorities for powering on the cores based on the aging characteristics.

39. A non-transitory computer-readable storage medium comprising code, which, when executed by a processor, causes the processor to perform operations for improving effective aging of a multi-core processor, the non-transitory computer-readable storage medium comprising
code for determining aging characteristics of two or more cores of the multi-core processor; and
code for assigning priorities for powering on the cores based on the aging characteristics.
